(19) United States
(12) Patent Application Publication
(10) Pub. No.: US 2018/0096215 A1
(43) Pub. Date: Apr. 5, 2018

(54) OPERATOR GUIDED INSPECTION SYSTEM AND METHOD OF USE

(71) Applicants: Thomas Alton Bartoshesky, Ann Arbor, MI (US); Jonathan Douglas Williams, Farmington Hills, MI (US); Robert Fuelep Biro, San Jose, CA (US)

(72) Inventors: Thomas Alton Bartoshesky, Ann Arbor, MI (US); Jonathan Douglas Williams, Farmington Hills, MI (US); Robert Fuelep Biro, San Jose, CA (US)

(21) Appl. No.: 15/282,660

(22) Filed: Sep. 30, 2016

(51) Int. Cl. G06K 9/32; G06K 9/00; G06T 7/00; H04N 5/225

(52) U.S. Cl. CPC G06K 9/3208; G06K 9/00671; G06T 7/0044; G06T 2207/30164; H04N 5/2252; G06T 2207/20221; G06T 7/003

(57) ABSTRACT

A machine vision inspection system that is automated but also under operator guidance. The operator moves the inspection system into a relative inspection volume until a ghost image is initiated, locks-in on the ghost image, and then initiates the automated inspection. Typically, the inspection system is handheld with a display that an operator can move into difficult to reach volumes to initiate the inspection.

### TECHNICAL FIELD

The present disclosure relates to operator guided inspection systems. More particularly, automated handheld systems configured to utilize ghost images or other graphical elements to assist an operator in an automatic inspection process.

### BACKGROUND

The statements in this section merely provide background information related to the present disclosure. Accordingly, such statements are not intended to constitute an admission of prior art.

Currently, machine vision inspection systems are utilized to verify correct part installation. For example, a machine vision system can verify that every expected part is included and installed within proper tolerances.

### BRIEF SUMMARY OF THE INVENTION

In one embodiment, a method to use an operator guided inspection system comprises: having an operator login to the operator guided inspection system; selecting an inspection task; confirming selection of the inspection task; initiating a live image acquisition; providing a ghost image to the operator to enable the operator to lock-in an optimal position for the operator guided inspection system; running a location algorithm to determine a current operator guided inspection system position versus the optimal position; notifying the operator when the current operator guided inspection system matches the optimal position within a pre-determined tolerance; performing object inspections on at least one object when the pre-determined tolerance is in effect; notifying the operator whether or not the object or objects meet(s) one or more specified criterion; generating a report based upon results of the object inspections; and archiving the results of the object inspections within the operator guided inspection system.

In one embodiment, the operator guided inspection system comprises a processor; a camera; a programmable illumination; a touch screen display; a graphical user interface; machine vision and image processing algorithms; a location sensor; a motion sensor; and a handheld housing in which the other system elements are located.

In one embodiment, the location sensor can utilize a global positioning system (GPS).

In one embodiment, the ghost image is an ideal representation of the live image.

In one embodiment, the ghost image is a transparent overlay configured to enable the operator to view both the ghost image and live image acquisition simultaneously.

In one embodiment, initiating a live image acquisition also includes conducting an Optical Character Recognition (OCR). The system can utilize the OCR and compare it to an existing library to conduct an Optical Character Verification (OCV), which can then generate a font file. An alignment of the ghost image would be automatically generated from the font file. The characters to be read would be displayed in a transparent over lay that is the correct size and can be part of the ghost image.

In one embodiment, the method further comprises the step of automatically expanding the area of interest and displaying inspection results and graphics enabling the operator to view the critical area more easily and in better detail than possible with the naked eye.

In one embodiment, the method further comprises the step of providing dynamic calibration of the tolerance based upon whether or not the object or objects meet(s) one or more specified criterion.

In one embodiment, the method further comprises the step of transmitting the results to an external data base or control system.

In one embodiment, the notifying the operator step includes an audible cue.

In one embodiment, wherein the notifying the operator step includes a visual cue.

In one embodiment, the notifying the operator step includes a vibrational cue.

In one embodiment, the ghost image can be generated with pre-existing font data that is integrated with the live image acquisition.

The scope of the invention is defined by the claims, which are incorporated into this section by reference. A more complete understanding of embodiments on the present disclosure will be afforded to those skilled in the art, as well as the realization of additional advantages thereof, by consideration of the following detailed description of one or more embodiments. Reference will be made to the appended sheets of drawings that will first be described briefly.

### BRIEF DESCRIPTION OF THE DRAWINGS

A clear understanding of the key features of the invention summarized above may be had by reference to the appended drawings, which illustrate the method and system of the invention, although it will be understood that such drawings depict preferred embodiments of the invention and, therefore, are not to be considered as limiting its scope with regard to other embodiments which the invention suggests. Accordingly:

FIG. 1 shows a method embodiment of the invention.

FIG. 2 shows a front-perspective view of an operator guided inspection system and system screen.

FIG. 3 shows a network diagram of an operator guided inspection system.

FIG. 4 shows a back-perspective view of an operator guided inspection system.

FIG. 5 shows a network diagram of an operator guided inspection system with a remote input device such as a camera.

FIG. 6 shows a fingertip remote input device.

FIG. 7 shows a wand remote input device.

### DETAILED DESCRIPTION

Unfortunately, many times the general machine vision system described in the background is unable to access an area or volume to gain the view required for the inspection. A robot mounted camera could access some of these areas. But, a robot actuator is an expensive, complex and space consuming solution. Additionally unanticipated variation in location and orientation of the parts to be inspected would be difficult for a robot to handle. These hard to reach places and highly variable product positions can sometimes be reached with a handheld device under the guidance of an operator. However, it can be difficult for an operator to achieve the proper orientation of the handheld device in order to make a proper inspection. Therefore, the present disclosure discusses methods for an operator to achieve proper orientation with a machine vision system and make a successful inspection with a machine vision system.

In one embodiment, an Operator Guided Inspection System (OGI) consists of a hand held fully portable processor, camera, programmable illumination, touch screen display, graphical user interface, wireless communications to interface to ERP and other planning and control systems, machine vision and image processing algorithms, location sensor and motion sensors. The Operator Guided Inspection System could be used for quality control applications such as detecting soft seated electrical connectors in aircraft and automobiles. Soft seated connectors can vibrate loose and create safety and operational issues. Often these connectors are behind other components and not secured to a rigid mount making it impossible to use a fixed camera inspection system. The OGI system can also be used for error proofing chemical and food container labeling. Containers are moved and placed by forklifts and are not accurately located or orientated, making it impossible to inspect with fix camera systems. The Operator Guided Inspection System gives the operator the ability to adjust to a non fixtured inspection target. OGI could be valuable anywhere manual inspections are being performed. OGI provides machine vision based automated inspection in areas that would not be possible with fixed mount machine vision systems. OGI also provides archived images and data records of the as built or as shipped products.

In one embodiment the camera is mounted on a wand or on a fingertip via a glove, brace, or thimble.

In one embodiment the display and processor are part of a wearable heads-up display and processor. Inspection feedback, actual position and camera position are presented to the operator in a blended reality image.

The system allows an operator to login and select a preprogrammed inspection task. Once the task is selected and confirmed by the operator, the system goes into live image display. Superimposed on the live image, a partially transparent image “ghost image” of the target is displayed. This ghost image is a critical aid to help the operator position the inspection system. Using the live display of the actual image the operator aligns the ghost image with the actual image. When acceptable alignment is achieved the inspection can be automatically or manually triggered. Upon an inspection trigger the OGI uses a variety of image processing and machine vision tools to determine a pass or fail condition of the target object. Unique to an operator guided inspection system are vision tools that assure camera location and orientation and provide dynamic scaling to compensate for cameras position variability. Multiple fixturing algorithms are used to progressively run and fixture the inspection algorithms. Additional algorithms to identify unique features outside the area of interest, position sensors and motion sensors would be used to assure the system was inspecting the correct object and progressing through the objects to be inspected, to prevent accidentally inspecting the same object more than once.

Upon inspection the system displays an enlarged image of the “area of interest” for the operator. This zoomed-in-image provides additional opportunities for the operator to manually inspect the object and review the inspection results. The zoomed in result image includes selected inspection result graphics to clearly indicate the results to the operator. The zoomed-in-image of a passing result would have a green border. The zoomed in image of a failed result would have a red border.

A typical inspection routine would include multiple vision algorithms to verify and gauge the object's dimensions, verify color, verify presence, position and location, verify count and verify text presence and content. Algorithms to decode linear and 2D Symbologies could also be used to select the object or verify code content.

For applications using OCV, it is possible to generate the ghost image from the font file instead of a previously taken image of the character string. This is an automated generation of the ghost image and allows the system to guide the operator to verify strings of characters the system has not previously imaged or trained.

The process to automatically generate the expected string of characters to be verified would b: Receive the string to be verified from the factory broadcast system or pre-loaded list. Then the operator guided inspection system would create a ghost image of the characters by using the font file. The font file is a standard list of characters in the specified style of the selected font. From the font file we would build a ghost image that would be the correct characters, shape, style and size. This would be displayed for the operator as a transparent image to guide the image acquisition and inspection like a manually generated ghost image. The advantage is the system would not have to pre capture an image of all of the potential character strings to be verified. This could be especially useful for verifying serial numbers, since each part can have a different serial number.

As an example: the operator guided inspection system could be used to read the chemical names on chemical drum labels. There are 1000s of chemicals names. To pre-train a ghost image for each would not be practical. To automatically generate the ghost image from the font or computer aided drafting (CAD) file makes this application feasible.

CAD files could be used to generate ghost images of parts or objects automatically. Hence, a ghost image can be generated with pre-existing font data that is integrated with the live image acquisition.

On screen “soft buttons” could be programmed as part of the graphical user interface to make it easy and obvious for an operator to select and navigate through the inspection sequence. Soft buttons would provide operator input for selecting the inspection object, approving the pass or fail results or overriding an inspection result. Process activation and control could also be through voice commands. Result images with Meta data and result data would be archived for future analysis. Images can be retrieved using Meta data search.

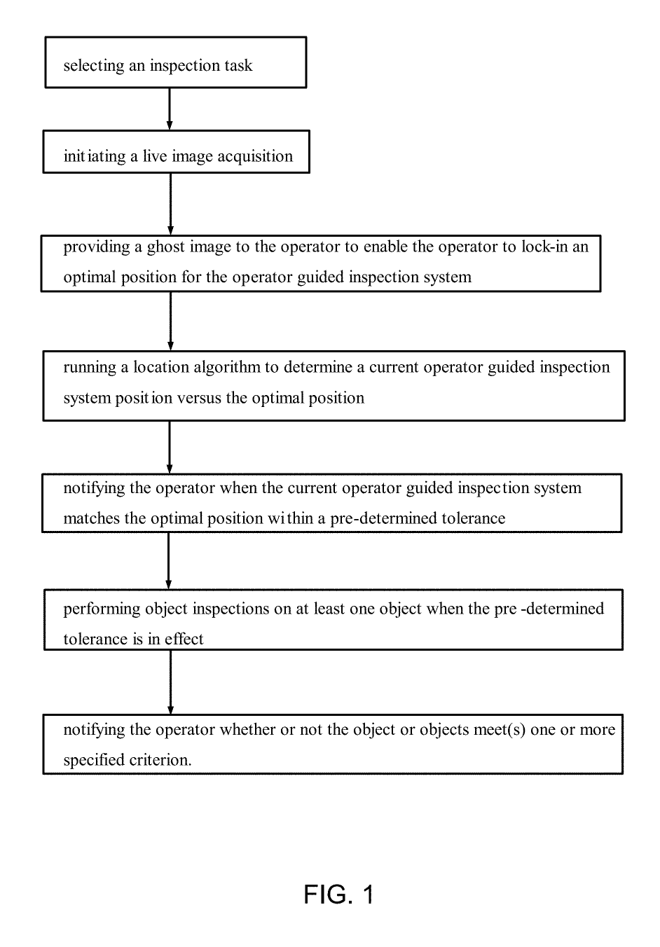

FIG. 1 shows a method embodiment of the invention. Shown are the following steps: step 101, selecting an inspection task; step 102 initiating a live image acquisition; step 103 providing a ghost image to the operator to enable the operator to lock-in an optimal position for the operator guided inspection system; step 104 running a location algorithm to determine a current operator guided inspection system position versus the optimal position; step 105 notifying the operator when the current operator guided inspection system matches the optimal position within a pre-determined tolerance; step 106 performing object inspections on at least one object when the pre-determined tolerance is in effect; and step 107 notifying the operator whether or not the object or objects meet(s) one or more specified criterion.

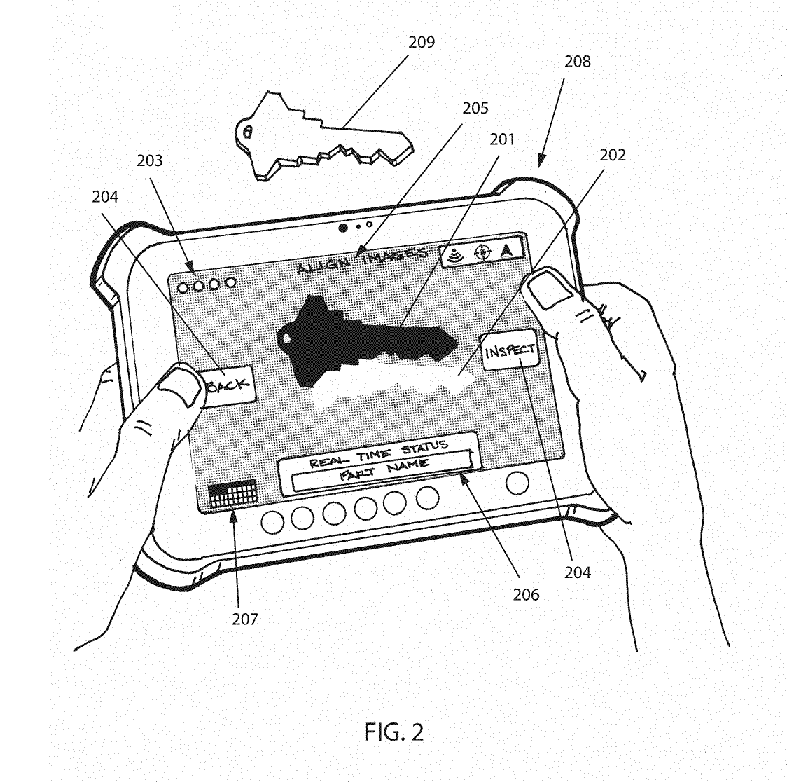

FIG. 2 shows a perspective view of an operator guided inspection system and system screen. Shown are a part image 201, alignment ghost image 202, process status indicator 203, navigation buttons 204, instructions 205, selection and current status 206, multi-results display 207, a hand-held housing 208, and a part 209.

The multi-results display 207, can be a matrix of individual blocks. Each block represents an inspection and has multiple states. For example, an empty block designates the inspection has not been run, red is fail, green is pass, and yellow means the operator over-rode the inspection results. Additionally more colors could be added to designate other conditions, for example blue if the part is within tolerance but should be manually inspected.

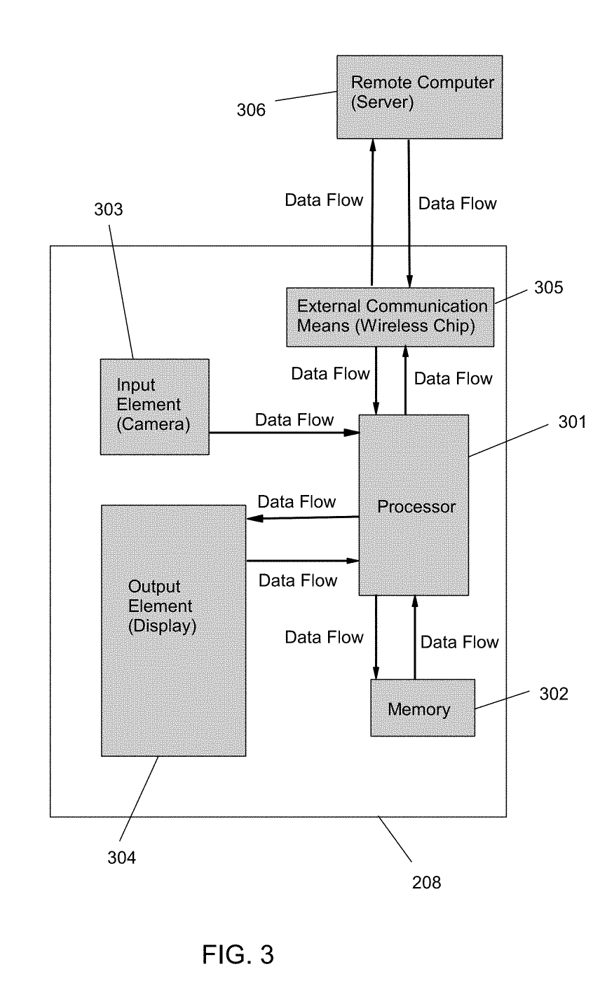

FIG. 3 shows a network diagram of an operator guided inspection system. Shown are a processor 301, memory 302 (random access memory and/or read only memory), input elements 303 such as the camera, output elements 304 such as the display which a user can use to view and input data, a hand-held housing 208, communication means 305 such as a wireless chip, and a remote computer 306 upon which data can be downloaded. Software is utilized in the processor and memory to operate the system.

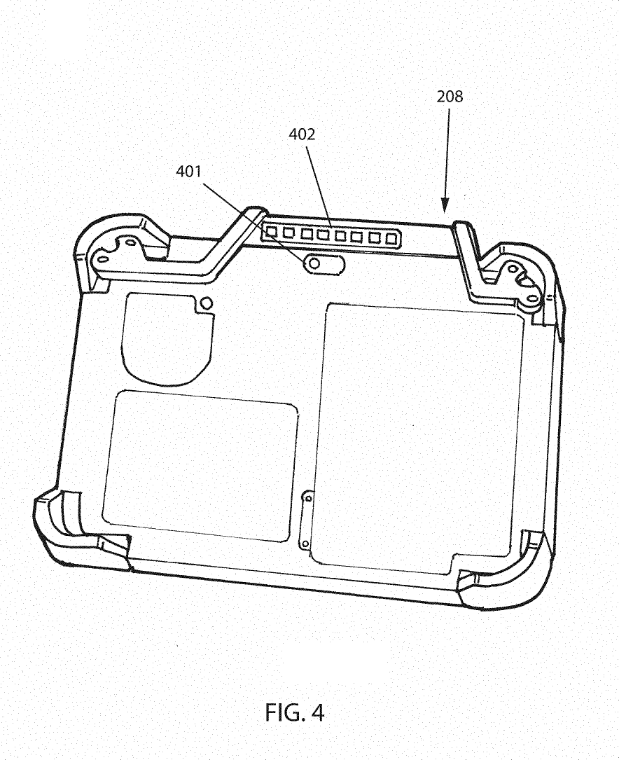

FIG. 4 shows a back-perspective view of an operator guided inspection system. Shown are a camera 401, light 402 for illumination, and hand-held housing 208.

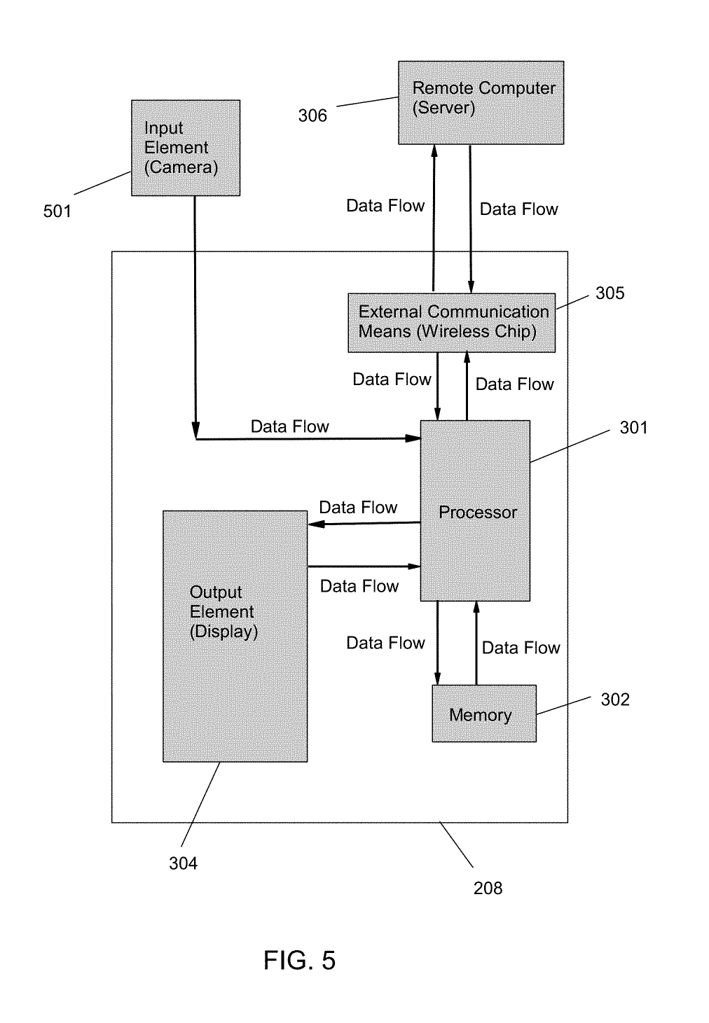

FIG. 5 shows a network diagram of an operator guided inspection system with a remote input device such as a camera. Shown are a processor 301, memory 302 (random access memory and/or read only memory), input elements 501 such as the camera, output elements 304 such as the display which a user can use to view and input data, a hand-held housing 208, communication means 305 such as a wireless chip, and a remote computer 306 upon which data can be downloaded, wherein input elements 501 are located outside of the hand-held housing 208. Software is utilized in the processor and memory to operate the system.

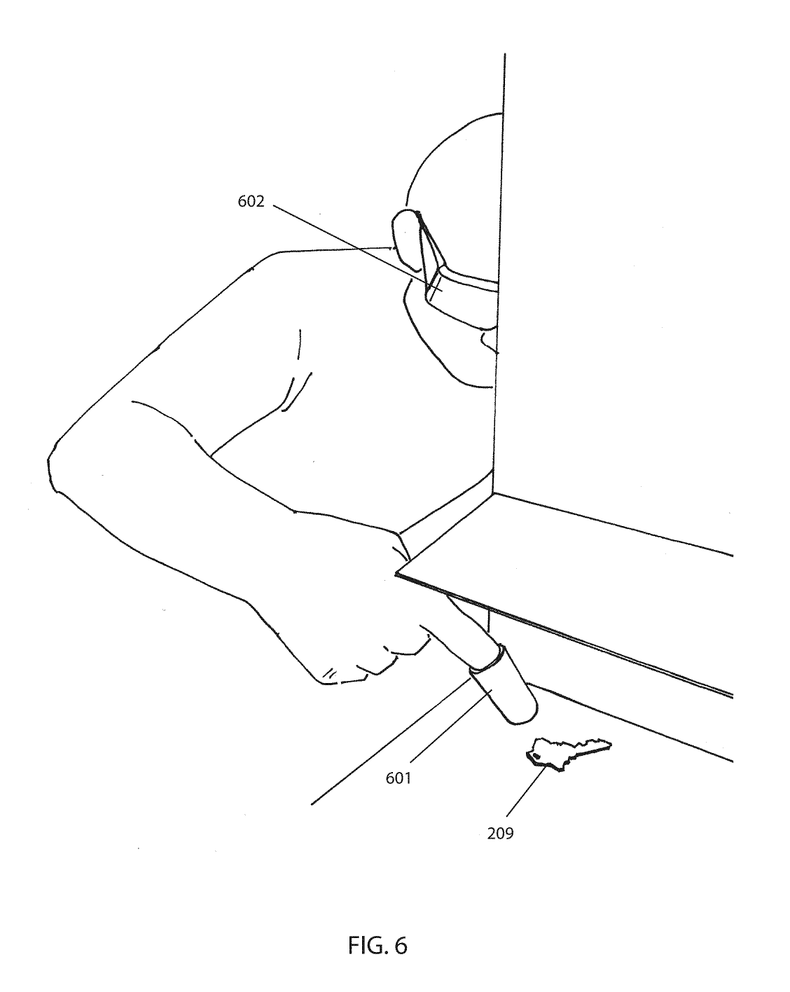

FIG. 6 shows a fingertip remote input device. Shown are fingertip remote input device and lighting 601, a wearable heads-up display 602 that can have an integrated processor, and part 209.

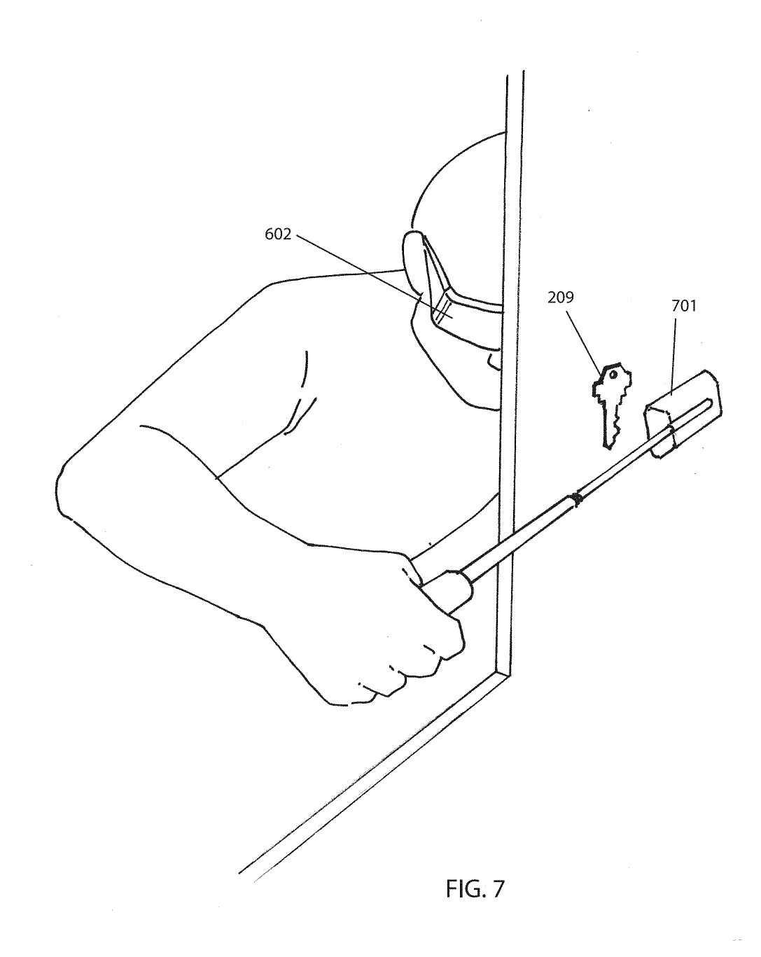

FIG. 7 shows a wand remote input device. Shown are a wand remote input device and lighting 701, a wearable heads-up display 602 that can have an integrated processor, and part 209.

All patents and publications mentioned in the prior art are indicative of the levels of those skilled in the art to which the invention pertains. All patents and publications are herein incorporated by reference to the same extent as if each individual publication was specifically and individually indicated to be incorporated by reference, to the extent that they do not conflict with this disclosure.

While the present invention has been described with reference to exemplary embodiments, it will be readily apparent to those skilled in the art that the invention is not limited to the disclosed or illustrated embodiments but, on the contrary, is intended to cover numerous other modifications, substitutions, variations, and broad equivalent arrangements.

We claim:

1. A method to use an operator guided inspection system comprising:
selecting an inspection task;
initiating a live image acquisition;
providing a ghost image to the operator to enable the operator to lock-in an optimal position for the operator guided inspection system;
running a location algorithm to determine a current operator guided inspection system position versus the optimal position;
notifying the operator when the current operator guided inspection system matches the optimal position within a pre-determined tolerance;
performing object inspections on at least one object when the pre-determined tolerance is in effect; and
notifying the operator whether or not the object or objects meet(s) one or more specified criterion.

2. The method of claim 1, wherein the operator guided inspection system comprises a processor; a camera; a programmable illumination; a touch screen display; a graphical user interface; machine vision and image processing algorithms; a location sensor; a motion sensor; and a handheld housing.

3. The method of claim 2, wherein the camera is located within the handheld housing.

4. The method of claim 2, wherein the camera is mounted on a fingertip via a glove, or brace, or thimble.

5. The method of claim 2, wherein the camera is mounted on a wand.

6. The method of claim 1, wherein the ghost image is an ideal representation of the live image.

7. The method of claim 1, further comprising the step of providing an operator login as the first step.

8. The method of claim 1, further comprising the step of confirming selection of the inspection task immediately after the selecting step.

9. The method of claim 1, wherein the ghost image is a transparent overlay configured to enable the operator to view both the ghost image and live image acquisition simultaneously.

10. The method of claim 1, further comprising the step of enabling the operator to expand a view or reduce a view of an area of interest, prior to the step of providing a ghost image.

11. The method of claim 1, further comprising the step of magnifying an area of interest, focusing on a critical feature of the inspection, and displaying this area of interest for the operator, after the providing step.

12. The method of claim 1, further comprising the step of displaying result graphics on a magnified image to clearly indicate an inspection result.

13. The method of claim 1, further comprising the step of providing dynamic calibration of the tolerance based upon whether or not the object or objects meet(s) one or more specified criterion.

14. The method of claim 1, wherein the notifying the operator step includes an audible cue.

15. The method of claim 1, wherein the notifying the operator step includes a visual cue.

16. The method of claim 1, wherein the notifying the operator step includes a vibrational cue.

17. The method of claim 1, further comprising the step of generating a report based upon whether or not the object or objects meet(s) one or more specified criterion.

18. The method of claim 1, further comprising the step of archiving whether or not the object or objects meet(s) one or more specified criterion within the operator guided inspection system.

19. The method of claim 1, further comprising the step of transmitting whether or not the object or objects meet(s) one or more specified criterion to an external data base.

20. The method of claim 1, wherein the ghost image is generated with pre-existing font data that is integrated with the live image acquisition.
